(19) United States
(12) Patent Application Publication
(10) Pub. No.: US 2026/0043711 A1
(43) Pub. Date: Feb. 12, 2026

(54) METHODS AND SYSTEMS FOR MONITORING, DIAGNOSIS AND PREDICTION OF HEALTH OF AN INDUSTRIAL MACHINE HAVING A ROTATING COMPONENT

(71) Applicant: ENERTICS INC., Milton (CA)

(72) Inventors: Sagoo Gurinder SINGH, Milton (CA); Varinder SEMBHI, Milton (CA); Tarlochan S. SIDHU, Milton (CA)

(21) Appl. No.: 18/995,976

(22) PCT Filed: Apr. 19, 2023
(86) PCT No.: PCT/CA2023/050531

§ 371 Date: Jan. 17, 2025

Related U.S. Application Data
(60) Provisional application No. 63/332,679, filed on Apr. 19, 2022.

(51) Int. Cl. G01M 13/045; G01P 3/56; G05B 23/02; G06N 20/00

(52) U.S. Cl. CPC G01M 13/045; G01P 3/56; G05B 23/0221; G05B 23/024; G05B 23/0283; G06N 20/00

(57) ABSTRACT

A method for monitoring, diagnosing and predicting the health of an industrial machine having a rotating component and a sensor coupled to the industrial machine. The method containing the steps of receiving, from the at least one sensor, machine health data corresponding to a current operating condition of the industrial machine; generating, using a machine health module, a machine health status corresponding to the current operating condition of the industrial machine based on the machine health data; and communicating, to an electronic device, a representation of the machine health status. Also disclosed is a method for monitoring a plurality industrial machines having a rotating component; a non-transitory memory containing instructions and statements which, when executed by a processor, cause the processor to perform the method disclosed herein, a system for monitoring an industrial machine having a rotating component and a device to perform the method disclosed herein.

### CROSS-REFERENCE TO RELATED APPLICATIONS

The present disclosure claims priority from U.S. provisional patent application No. 63/332,679, filed Apr. 19, 2022, entitled “METHODS AND SYSTEMS FOR MONITORING AN INDUSTRIAL MACHINE HAVING A ROTATING COMPONENT”, the entirety of which is hereby incorporated by reference.

### TECHNICAL FIELD

The present disclosure relates to condition monitoring of industrial machines, and particularly, to systems and methods for monitoring, diagnosing and predicting the health of an industrial machine having a rotating component.

### BACKGROUND

Industrial machines including rotating components are used in a wide range of critical and non-critical industrial applications, and replacing them can be costly. Electrical and rotating equipment benefit from routine maintenance, to identify mechanical or electrical issues before failures occur. However, downtime and equipment failure may occur unexpectedly, incurring high costs for repair or replacement along with lost revenue.

Operational and business conditions globally are continually evolving, particularly now as the power and manufacturing industry is undergoing a rapid transformation. Distributed generation, renewables, smart grids, storage and prosumers are accelerating the rate of change within the industry. Similarly, manufacturing is becoming advanced with the introduction of such concepts as Industry 4.0. This means that operational conditions and demands are changing quickly, requiring power and utility companies to refine how they monitor and maintain operating assets.

Equipment eventually fails over time, reliability decreases, and losses increase (efficiency decreases) over time prior to most catastrophic failures. Although some equipment faults are instantaneous, most catastrophic faults that impact production are the result of a failure in the implementation of a maintenance program. Proper implementation of a maintenance program has been shown to reduce energy consumption in plants, while also reducing unplanned production downtime. Accordingly, there is a need for a method of remote and continuous monitoring and diagnosing motors and other industrial machines in industrial applications.

### SUMMARY

Example embodiments provide a system for monitoring an industrial machine having a rotating component. The system uses a sensor device, connected to the machine being monitored, that senses a variety of machine health data. This machine health data is evaluated by a machine health module in order to generate a health status of the machine, along with related alerts and operational instructions.

In various examples, the present disclosure describes a technical solution that enables the health status associated with a current state of the machine to be computed, or the health status associated with a future state of the machine to be predicted. In examples, the technical solution may provide a benefit that sensor data is gathered and processed automatically using IOT devices, for example, from a range of sensor sources including vibration, temperature, acoustic, ultrasound, magnetic field, current and humidity sensors, among others. In examples, said sensor data can be integrated for comprehensive analysis of machine health. An indication of the current or predicted health status of the machine can be displayed to a user in a user interface (UI). Indication of a health status of the machine may help to inform the user to a need to perform maintenance on the machine, or to an anomaly present in the operation of the machine that may lead to a fault condition. This can provide the technical advantage that information is provided (e.g., displayed via a UI) to optimize asset performance, to remotely diagnose health conditions of the machine and to mitigate a risk of machine faults or failures.

In examples, the solution provides a benefit of automatically informing a user whether a machine health condition or concern has been detected, diagnosed or predicted, for example, through alerts or other notifications, thereby minimizing a risk of machine failure. In examples, in response to dispatching an alert or other notification, a technical effect of the system is the ability to generate instructions or other recommendations for a machine controller or user of the system to address or remedy any concerns with the machine.

In an example embodiment, disclosed is a method for monitoring an industrial machine having a rotating component and at least one sensor coupled to the industrial machine, the at least one sensor for sensing machine health data corresponding to a current operating condition of the industrial machine, the method having the steps of: receiving, from the at least one sensor, the machine health data; generating, using a machine health module, a machine health status corresponding to the current operating condition of the industrial machine based on the machine health data; and communicating, to an electronic device, a representation of the machine health status, to cause the electronic device to provide an output of the representation of the machine health status.

In an example of the preceding example aspect of the method, the method further comprises: determining, by the machine health module, that the current operating condition of the industrial machine corresponds to a non-optimal operating condition, based on the machine health status; in response to determining that the operating condition of the industrial machine is non-optimal: generating, by the machine health module, an alert; and communicating the alert to the electronic device.

In an example of a preceding example aspect of the method, the method further comprises: determining, by the machine health module, that the current operating condition of the industrial machine corresponds to a non-optimal operating condition, based on the machine health status; in response to determining that the operating condition of the industrial machine is non-optimal: generating, by the machine health module, an operational instruction; and communicating the operational instruction to the electronic device.

In an example of a preceding example aspect of the method, the method further comprises: diagnosing, by the machine health module, a machine health condition of the industrial machine, based on the machine health data.

In an example of a preceding example aspect of the method, wherein generating the machine health status corresponding to the current operating condition of the industrial machine comprises: computing one or more machine health index values; and computing the machine health status based on the one or more machine health index values.

In an example of the preceding example aspect of the method, wherein generating the machine health status corresponding to the current operating condition of the industrial machine further comprises: predicting, by a time-series prediction algorithm, a future state of the industrial machine.

In an example of the preceding example aspect of the method, wherein the time-series prediction algorithm is a modified Holt exponential smoothing algorithm.

In an example of a preceding example aspect of the method, wherein the industrial machine is a first machine, the first machine being coupled to a second machine and configured as a driver for driving the second machine, and wherein generating the machine health status corresponding to the current operating condition of the industrial machine further comprises: determining, by a resolution compensation algorithm, a true peak supply frequency from a magnetometer spectrum; determining a synchronous speed of the first machine based on the true peak supply frequency; and determining a rotating speed of the second machine based on the synchronous speed of the first machine.

In an example of a preceding example aspect of the method, wherein the industrial machine is a first machine, the first machine being coupled to a second machine and configured as a driver for driving the second machine, and wherein generating the machine health status corresponding to the current operating condition of the industrial machine further comprises, determining, by a resolution compensation algorithm, a true peak supply frequency from a magnetometer spectrum; determining a synchronous speed of the first machine based on the true peak supply frequency; determining, by the resolution compensation algorithm, a true vibration frequency from a vibration spectrum; determining an operating speed of the first machine based on the true vibration frequency; and determining a rotating speed of the second machine based on the synchronous speed and the operating speed of the first machine.

In an example of a preceding example aspect of the method, wherein the electronic device is caused to display a user interface (UI) enabling output of the representation of the machine health status.

In an example of the preceding example aspect of the method, wherein the representation of the machine health status is configurable based on a multi-tenant application using at least one of: a user account, a user permissions, a user group, a user role, or a site.

In an example of a preceding example aspect of the method, wherein the representation of the machine health status includes a plot of at least a portion of the machine health data over time.

In an example of a preceding example aspect of the method, wherein the at least one sensor includes at least one of: a temperature sensor, a vibration sensor, an acoustic sensor, an ultrasonic sensor, a magnetic sensor, a current sensor, an orientation sensor, or a humidity sensor.

In an example of a preceding example aspect of the method, wherein the machine health data includes at least one of: machine temperature data, machine vibrational data, machine acoustic data, machine ultrasound data, machine magnetic data, machine electrical data, machine operational data, machine orientation data, or machine humidity data.

In an example of any of the preceding example aspects of the method, wherein the machine health module includes a trained prediction machine learning (ML) model.

In an example of the preceding example aspect of the method, the method further comprises: training a prediction ML model to provide the trained prediction ML model by: obtaining multiple historical machine health data samples corresponding to a respective historical operating condition of the industrial machine; and training the prediction ML model based on the historical machine health data samples.

In an example of a preceding example aspect of the method, wherein the machine health module is configured to automatically send the alert to at least one electronic address.

In an example of a preceding example aspect of the method, wherein the machine health module is configured to automatically send the alert to at least one telephone number via short messaging service.

In an example of a preceding example aspect of the method, wherein the machine health module is configured to automatically send the operational instruction to a controller of the industrial machine, wherein the controller is configured to control operation of the industrial machine.

In an example of a preceding example aspect of the method, wherein the machine health module is configured to communicate with a supervisory control and data acquisition (SCADA) system.

In an example of a preceding example aspect of the method, the method further comprises: generating, using the machine health module, a sensor health status corresponding to the current operating condition of the at least one sensor, based on the machine health data; and communicating, to an electronic device, a representation of the sensor health status, to cause the electronic device to provide an output of the representation of the sensor health status

In an example of the preceding example aspect of the method, the method further comprises: diagnosing, by the machine health module, a sensor operation issue of the at least one sensor, based on the sensor health status.

In an example of a preceding example aspect of the method, wherein the sensor health status includes at least one of a power status of the sensor device, a communications status of the sensor device or a machine trouble status of the sensor device.

In an example of a preceding example aspect of the method, wherein the machine health data is received continuously.

In an example of a preceding example aspect of the method, wherein the machine health data is received at pre-determined intervals.

In an example of a preceding example aspect of the method, wherein the machine health data is received over an equipment operational period.

In a second example embodiment, disclosed is a method for monitoring a plurality industrial machines having a rotating component, and a respective sensor device for sensing machine health data corresponding to a current operating condition of the respective industrial machine, the method comprising: receiving, from a base unit, machine health data corresponding to a plurality of sensor devices identified as being in proximity to the base unit; generating, using a machine health module, a machine health status corresponding to the current operating condition of each of the plurality of industrial machines, based on the machine health data; and communicating, to an electronic device, a representation of the machine health status of each of the plurality of industrial machines, to cause the electronic device to provide an output of the representation of the machine health status of each of the plurality of industrial machines.

In a third example embodiment, disclosed is a non-transitory memory containing instructions and statements which, when executed by a processor, cause the processor to perform the method as disclosed herein.

In a fourth example embodiment, disclosed is a system for monitoring an industrial machine having a rotating component, the system comprising: a sensor device connected to the industrial machine, the sensor device including at least one sensor and configured for sensing machine health data corresponding to a current operating condition of the industrial machine; a machine health server; one or more processor devices; and one or more memories storing machine-executable instructions, which when executed by the one or more processor devices, cause the system to: receive, from the at least one sensor, the machine health data; generate, using a machine health module, a machine health status corresponding to the current operating condition of the industrial machine based on the machine health data; and communicate, to an electronic device, a representation of the machine health status, to cause the electronic device to provide an output of the representation of the machine health status.

In an example of the preceding example aspect of the system, wherein the machine health server includes a multi-layer data storage architecture including a database for storing historical machine health data, and the historical machine health data may include tags or data reference points for improving data retrieval.

In an example of a preceding example aspect of the system, wherein the machine health server is a cloud-based server.

In a fifth example embodiment, disclosed is a device for carrying out the method disclosed herein.

In a sixth example embodiment, disclosed is a sensor device for monitoring an industrial machine having a rotating component, comprising: at least one sensor for sensing machine health data; and a wireless module for transmitting machine health data sensed by the at least one sensor.

Additional advantages of the present disclosure will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference will now be made, by way of example, to the accompanying drawings which show example embodiments, and in which

FIG. 1 shows a schematic diagram of the machine monitoring system;

FIG. 2 is a flowchart of an example embodiment of machine monitoring architecture;

FIG. 3 is a schematic diagram of the sensor device;

FIG. 4 is a schematic diagram of a server of FIG. 1;

FIG. 5 is a block diagram of a base unit, according to an example embodiment.

FIG. 6 is a block diagram of a machine health module, according to an example embodiment;

FIG. 7 is a schematic diagram of a visual representation of a machine health condition assessment, according to an example embodiment.

Similar reference numerals may have been used in different figures to denote similar components.

### DETAILED DESCRIPTION

Techniques, devices and systems for machine monitoring are described herein. In some embodiments, the machine is a motor. In one embodiment machine health data is detected by sensors in a sensor device connected to the machine. Machine health data may include data such as temperature, vibration, orientation, current, acoustic, ultrasound, magnetic, humidity or other machine health indicating information. The following describes technical solutions of example embodiments with reference to accompanying drawings.

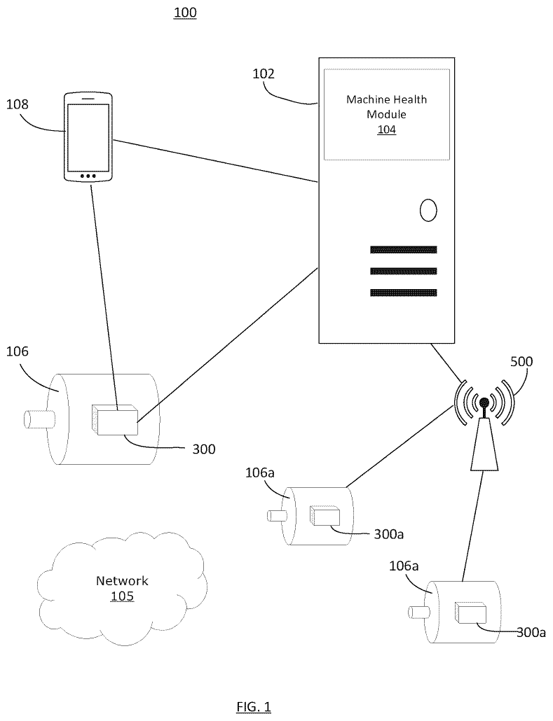

FIG. 1 illustrates a system 100 for monitoring a machine 106. The system 100 can be used to sense and monitor machine health indicating data. The system 100 can include a server 102 with a machine health module 104, a sensor device 300 connected to a machine 106, a base unit 500, and one or more electronic devices 108. In the example illustrated in FIG. 1, the machine 106 is a motor. It will be understood that, although the Figures are occasionally described with reference to a motor, the methods and systems described herein can also be used to monitor other industrial machines 106 that have rotating components, such as a generator, gearbox, pump, fan or blower, compressor, ball bearing, sleeve bearing or wind turbine, among others.

The server 102 includes a machine health module 104 which is configured to receive information from the sensor device 300 or the base unit 500. The information received from the sensor device 300 or base unit 500 can include a variety of information, including temperature(s) of the machine 106, machine vibrational information, machine acoustic information, machine orientation information, machine humidity information or machine electrical information, which can be monitored and assessed by the machine health module 104. The term “server”, in examples, is not intended to be limited to a single hardware device: the server 102 may include a server device, a distributed computing system, a virtual machine running on an infrastructure of a datacenter, or infrastructure (e.g., virtual machines) provided as a service by a cloud service provider, among other possibilities. Generally, the server 102 may be implemented using any suitable combination of hardware and software, and may be embodied as a single physical apparatus (e.g., a server device) or as a plurality of physical apparatuses (e.g., multiple machines sharing pooled resources such as in the case of a cloud service provider). At least some aspects or functions of the server 102 may also be performed by other devices, such as the sensor device 300 or the electronic device 108, such as in the case of edge computing (or edge AI).

In examples, the server 102 can be a cloud-based server. The system 100 illustrated in this example includes a cloud platform, which allows the data stored in the server 102 to be accessed and stored in various locations globally, for example, using GSM, BLE, WIFI, ZIGBEE. SIGFOX, or LORA. A server 102 that is accessible from various locations globally is beneficial for users of the system, for example, an operator and/or a manager who is not located in the industrial setting where the machine 106 is installed, can monitor the condition of the machine 106 without the need to frequently physically inspect or test the machine 106. In examples, data storage may include a multi-layer data storage architecture. In other examples, stored data (e.g., historical machine health data 625, or other stored data) may incorporate tags or data reference points for faster data retrieval and/or for optimizing system performance. In examples, the server 102 can be a public or private cloud-based server with a flexible infrastructure architecture. In examples, consumption of cloud-based resources can be scalable, provider-agnostic and responsive based on load requirement, for example, where additional cloud-based servers can be added to accommodate increased load requirements or to avoid downtime. In examples, the server 102 can be a cloud-based server such as a bare metal server, for example, where the cloud-based server is a physical server configured for private use by a single tenant.

The server 102 is configured to communicate with an electronic device 108 according to one or more communication protocols. The electronic device 108 is communicably linked to the server 102. The electronic device 108 can be a computer, laptop, smart phone, cell phone, tablet or any other electronic device that allows a user to monitor the sensed data from the sensor device 300 and the conditions of the machine 106. The server 102 is configured to send information from the system 100 to the electronic device 108.

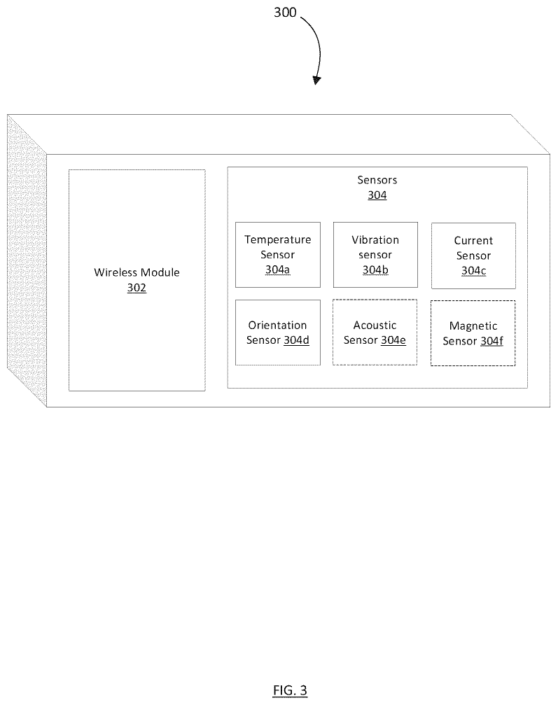

In some examples, the server 102 can be configured to communicate directly with the sensor device 300 via the wireless module 302, for example, by receiving the sensed data from the sensors 304. The server 102 can receive and store information from the sensors 304, such as machine temperatures, machine vibrational data etc. The sensor device 300 is a device that can connect to a machine 106 in order to sense or receive information from the machine 106. In some embodiments, for example, the sensor device 300 is an IOT device. The sensor device 300 can have sensors, and will be described in relation to FIG. 3.

In some industrial settings, there may be multiple machines 106 to be monitored. Many industrial settings have, for example, several motors that are used to power a variety of different industrial equipment. In the example illustrated in FIG. 1, multiple machines 106a are shown, each having its own respective sensor device 300a. In such an example, it may be beneficial to include a base unit 500 that can communicate with the sensor devices 300a. Although FIG. 1 depicts two machines 106a in communication with the base unit 500, it will be understood that any number of machines 106a can be deployed in an industrial setting and monitored by the system 100.

The base unit 500 is placed in a suitable area on the premises, for detecting the various sensor devices 300a. The base unit 500 is configured to communicate with the sensor devices 300a, for example, by receiving the sensed data from the sensor devices 300a. The base unit 500 can be configured to receive and store information from the sensor devices 300a. The base unit 500 can also be configured to communicate with the server 102. The server 102 can be configured to receive the machine health data stored in the base unit 500, or directly from the sensor devices 300a.

It may be desirable to have several base units 500 located on the premises to ensure that all machines 106a are in sufficient proximity to a base unit 500. Each of the base units 500 is in communication with the server 102 and can communicate in a similar manner with the server 102 and the sensor devices 300. When there are several base units 500 in the system 100, each base unit 500n can correspond to a subset of the machines 106a.

The server 102 can be configured to continuously request and receive the sensed data from the sensor device 300 or the base unit 500, such that the machine health module 104 can monitor the health of the machine 106 continuously. In other examples, the server 102 may be configured to receive the sensed data intermittently, such as every few seconds, minutes, hours, days, etc.

The server 102 may communicate with the electronic device 108 via cellular communication, for example, notifying the system 100 to take certain action, such as generating the health status 630 of the machine 106. The server 102 may provide a user interface, such as a web-portal. APL, analytics software or a dashboard for the electronic device 108 to connect to and control the system 100. The server 102 may include a memory for storing data from the sensor device 300. The server 102 may also store software updates to the system 100 and notify the electronic devices 108, for example by using a flag to indicate that a software update is available. An electronic device 108 may check the status of the software or the flag for software update in the server 102. The server 102 may also notify an electronic device 108 with the sensed results from the system 100, for example, by e-mails or short messages. The electronic device 108 may download the software from the server 102 via a suitable communication modality over the Internet, for example at M1 LTE/NB-IOT/2G.

The server 102 is configured to communicate with the sensor devices 300, the base unit 500 and the electronic devices 108 according to one or more communication protocols. In some examples, the server 102 communicates with sensor devices 300, the base unit 500 and the electronic devices 108 in a secured manner, for example, via secured links. The server 102 may communicate with the sensor device 300 or the base unit 500 of the system 100 via short message service (SMS), for example, notifying the system 100 to take certain action, such as generating an updated health status 630.

In some examples, the machine health module 104 includes a trained prediction machine learning (ML) model. The ML model can include a neural network or another machine learning technique running on a computing platform such as the server 102. Neural networks will be briefly described in general terms. A neural network can include multiple layers of neurons, each neuron receiving inputs from a previous layer, applying a set of weights to the inputs, and combining these weighted inputs to generate an output, which can in turn be provided as input to one or more neurons of a subsequent layer. The neural network is formed by joining a plurality of the foregoing single neurons. In other words, an output from one neuron may be an input to another neuron. An input of each neuron may be associated with a local receiving area of a previous layer, to extract a feature of the local receiving area. The local receiving area may be an area consisting of several neurons. A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others. In examples, RNNs may include a long short-term memory (LSTM) architecture for processing, classifying and making predictions from time-series data such as the machine health data 600. In examples, an LSTM architecture may include a cell, an input gate, an output gate and a forget gate, or another LSTM architecture may be used. In examples, other machine learning algorithms may be implemented by the machine health module 104, for example, nearest neighbor algorithms, Bayes algorithms, random forest, regression and other forms of predictive analytics, support vector machines (SVMs) and/or clustering, among others.

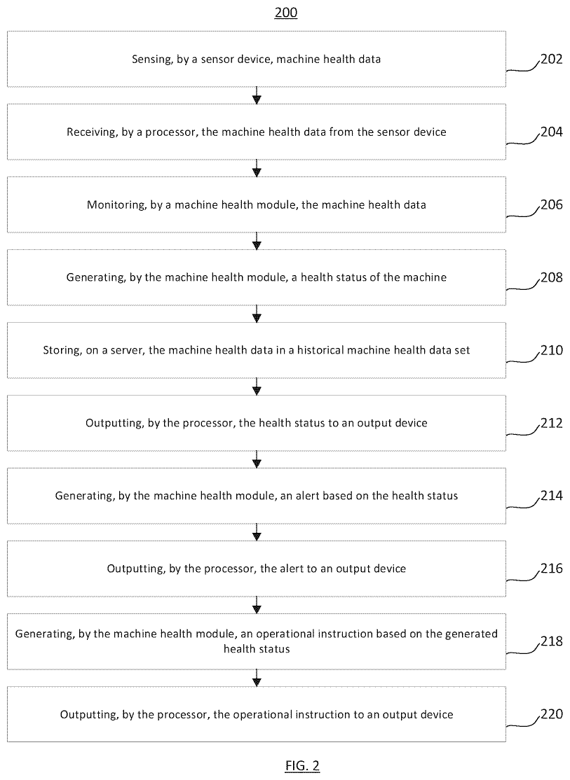

In order to generate the health status 630 of the machine 106, the machine learning model needs to be trained and tested. Training a ML model generally involves inputting training data (e.g., labelled or unlabeled training data) into an untrained ML model, processing the training data using the ML model, collecting the output generated by the ML model (e.g. based on the inputted training data), and comparing the output to a desired set of target values. The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function. In the system 100, the neural network or another machine learning technique can be trained using any of a number of machine learning techniques, such as supervised, unsupervised, or semi-supervised learning techniques, using a suitable set of training data, for example, a subset of the historical machine data 625 obtained from each of the sensors 304 and other sources. FIG. 2 is a flowchart illustrating a method 200 for monitoring the machine 106 using the sensor device 300 and the machine health module 104.

In method 200, at step 202, the sensors 304 in the sensor device 300 detect machine health data. In some embodiments, the machine health data includes machine temperatures, machine vibrational information, machine electrical information, machine acoustic information, machine ultrasound information, machine magnetic information, machine humidity information and machine orientation information. The machine health data can generally include any information that can be detected by the sensors 304, for example machine temperature data, machine vibrational data, machine sound data, machine magnetic data, machine humidity data, machine electrical data, machine operational data (e.g. motor speed and load), machine orientation data or machine humidity data. In particular, the machine health data can include any information that may assist the system in determining a health status 630 of the machine 106, for example, the sensor device 300 may preprocess the machine health data and the machine health data may include preprocessed machine health data. In other examples, the machine health data may include environmental data gathered by sensors in an operating environment of the machine 106, for example, related to environmental conditions in which the machine is operating (e.g., ambient temperature, humidity, electromagnetic radiation, audible sound, pressure, among others). In some examples, the sensors 304 are configured to sense the machine health data continuously. In other examples, the sensors 304 are configured to sense the machine health data at discrete intervals, or only during the operational period of the machine 106 (i.e. when the machine 106 is in operation).

At step 204, the server 102 receives, from the wireless module 302, the machine health data sensed from the sensors 304. In some examples, the wireless module 302 is configured to send raw or preprocessed data sensed by the sensors 304. In other examples, the wireless module 302 can be configured to continuously receive the sensed data from the sensors 304 and can identify when the sensed information changes. For example, the wireless module 302 may detect when a certain machine component, such as a motor bearing, has increased in temperature. In this regard, the wireless module 302 can then send the sensed information to the server 102 upon detecting the change in the sensed information. In other examples, the wireless module 302 is configured to continuously send the sensed information form the sensors 304 to the server 102. In yet another example, the wireless module 302 may be configured to send the sensed data to the server 102 intermittently, or at a fixed time interval that provides adequate information for monitoring the machine 106.

When there are multiple machines 106a being monitored by the system 100, the server 102 may receive the machine health data corresponding to each machine 106a from the base unit. The base unit receives the sensed data from each of the sensor devices 300a and can send the compiled data to the server 102.

At step 206, the machine health module 104 monitors the data received by the server 102 from the sensor device 300. In some embodiments, the machine health module 104 monitors the machine health data continuously. In other examples, the machine health module 104 monitors the machine health data in discrete intervals, such as every hour, day, week, month etc. In some embodiments, the machine health module 104 can compute a variety of operational parameters for displaying to a user. For example, the machine health module 104 can determine the line frequency of the power that is fed into the machine 106. In other examples, the machine health module 104, using the frequency calculation, can determine the synchronous speed of the machine 106, for example, for determining the operating speed or rotating speed (e.g., RPM) of the machine 106 (e.g., a synchronous motor, an induction motor, etc.). In other examples, the machine health module 104 can estimate mechanical loading on the machine 106, quantify starts and stops, and estimate machine utilization and runtime, among others.

Having monitored the machine health data over time, the machine health module 104 can then determine the health status 630 of the machine 106, at step 208. In some embodiments, the machine health module 104 generates the health status 630 in real time. In such an example, the machine health module 104 may notify users only when the health status 630 passes a certain threshold, or changes from a “healthy” status to a “fault” status. The health status 630 of a machine 106 can include a variety of information regarding the health of the machine 106. For example, the health status 630 can include: descriptive analytics for identifying the current health status 630 of the machine 106; diagnostic analytics for evaluating past performance to determine details of failure or fault events, such as a machine 106 failure or other individual conditions affecting the machine 106; predictive analytics for predicting future outcomes based on historical patterns; or prescriptive analytics for recommending actions based on the descriptive, diagnostic and/or predicative analytics. It will be understood that the health status 630 can include any information or conclusion relating to the operation and health of the machine 106 that can be determined through analysis of the sensed machine health data.

In some embodiments, the health status 630 is generated in response to an input from an electronic device 108. For example, a user may plan to be in a particular area of the industrial setting and may want to check if there is any upcoming maintenance required on the machines 106 in that area. In such an example, a user may request a health status 630 of the machine(s) 106 in that area and the machine health module 104 can generate the health status 630 in response to the request.

The health status 630 is generally related to the sensed machine health data 600. For example, the health status 630 may be an indication that one of the parameters being monitored by the machine health module 104, such as the orientation of the machine 106, is within acceptable limits or has surpassed the acceptable limits, for example, as defined in the International Organization for Standardization Standard ISO 10816-3:2009, “Mechanical vibration—Evaluation of machine vibration by measurements on non-rotating parts—Part 3: Industrial machines with nominal power above 15 kW and nominal speeds between 120 r/min and 15 000 r/min when measured in situ”, the entirety of which is hereby incorporated by reference. In some embodiments, the health status 630 can include a summary of the machine health data 600 in real time, or over an operational period.

In other examples, the health status 630 can be predictive maintenance requirements. In such an example, the machine health module 104 can use all of the machine health data to evaluate the condition of the machine 106 and make predictions as to what component(s) of the machine 106 will require maintenance and when such maintenance should be performed.

In yet another example, the health status 630 can be related to the remaining lifetime of the machine 106. The machine health module 104 may use the machine health data that is monitored over time to determine the remaining life expectancy of the machine 106 based on the historical machine health data 625 and design parameters for the machine 106.

The health status 630 can be related to mechanical or electrical faults in the machine 106. For example, when the machine 106 is a motor, the health status 630 can relate to mechanical faults including motor unbalance, motor misalignment, structural looseness, bent rotor/shaft, mounting structure faults, soft foot, ball bearing faults, journal bearing faults, or early stage bearing faults. Similarly, when the machine 106 is a motor, the health status 630 can be related to electrical faults including line imbalances, single phasing, stator faults or rotor faults.

When the sensor device 300 has a vibration sensor 304b, as will be discussed in relation to FIG. 3, the health status 630 can include a vibration signature analysis (VSA), for example, a Fast Fourier Transform (FFT) vibration signature analysis. The machine health module 104 can use the machine vibration data in the machine health data to perform analytics and determine the operating reliability based on this vibrational data. When the sensor device 300 has a vibration sensor 304b, the vibration sensor 304b will be integrated into the sensor device 300 in a manner that allows the vibration sensor 304b to sense changes in the vibrations of the machine 106. In examples, the vibration sensor 304b can be a tri-axial (radial, axial & tangential) vibration sensor.

When the sensor device 300 has a current sensor 304c, as will be discussed in relation to FIG. 3, the health status 630 may be related to the efficiency of the machine 106 or failure predictions of the machine 106. The machine health module 104 may conduct electrical signature analysis allowing it to detect and predict a variety of faults in the machine 106. For example, when the machine 106 is an electric motor, electric motor phase unbalances (e.g. inductance and impedance) affect the current unbalances, and can cause motors to run hotter and reduce the motor's ability to produce torque. The percentage unbalance can be evaluated to determine efficiency reduction and additional heating of the electric motor.

In some examples, the sensor device 300 has both a vibration sensor 304b and a current sensor 304c. The vibration signature analysis evaluates the mechanical condition of the machine 106 while the electrical signature analysis evaluates the electrical conditions of the machine 106. Together, using at least the vibration and electrical signature analyses, the machine health module 104 can evaluate the health of the machine 106 as a whole.

When the sensor device 300 has a temperature sensor 304a, as will be discussed in relation to FIG. 3, the health status 630 can be related to the health of certain components in the machine 106. For example, when the machine 106 is an electric motor, excessive heat can cause several performance problems. Overheating causes the motor winding insulation to deteriorate quickly. Overheating in the motor occurs from a variety of reasons, for example, poor power quality such as overvoltage or under voltage conditions. If the supply voltage is higher than the rated voltage, the excess voltage is dropped in the motor windings, resulting in heat dissipation. Every electric motor has a design temperature and if a motor is operated at an incorrect current value, it begins to operate in a much warmer condition than the design temperature. Overheating also occurs when an electric motor is forced to operate in a high temperature environment. The machine health module 104 can monitor the temperatures throughout the machine 106 such that the health status 630 can indicate overheating conditions, or make determinations as to the cause of the overheating.

In addition to processing the machine health data to generate a health status 630, the machine health module 104 also stores the machine health data as historical machine health data 625, for example, in a database 620, on the server 102, at step 210. In some examples, the machine health module 104 is configured to monitor and store the machine health data throughout the lifetime of the machine 106. By monitoring the machine health data throughout the history of the machine 106, operators can refer back to historical data to determine when certain machine 106 issues arose, or to learn from past operational errors. In some examples, the machine health module 104 generates a plot of the machine health data over time, based on the historical machine health data 625. For example, the machine 106 may be one component in an industrial application, and it may be useful for operators to observe the temperature, vibrations or orientation of a machine 106 over time in order to identify patterns, compare to other events in the industrial setting, or take preventative actions. Storing the historical machine health data 625 also allows operators to observe trends after a machine 106 has failed, in order to take preventative measures for machine 106 that will be installed in the industrial setting. Additionally, storing the historical machine health data 625 can allow the system 100 to train and test the machine health module 104 using real operational data, such that, over time, the machine health module 104 will improve in its accuracy and consistency.

At step 212, the processor outputs the health status 630 to an output device, such as an electronic device 108. In some examples, the health status 630 may be sent to the electronic de % ice 108 via short messaging service (SMS) or via e-mail. In other examples, the machine health module 104 can include a web-portal or dashboard (e.g., HMI/GUI 640) for users to interact with, and the processor can output the health status 630 to the web-portal or dashboard for the user to observe. For example, when the machine health module 104 generates the health status 630 in real time, it can also be configured to output the health status 630 when it passes a certain threshold. In some examples, the machine health module 104 is configured to display the health status 630 to the web-portal/dashboard as an image. For example, the machine health module 104 may display the bearing temperature graphically, such that under normal operating conditions, the bearing temperature is displayed in green, and when the bearing temperature reaches a temperature that indicates a fault or which may cause faults if maintained, the bearing temperature may be displayed in red. Such visual indicators allow operators to quickly determine whether the machine 106 is operating properly, or if there are issues with the machine 106 that need to be addressed immediately. In examples, the web-portal or dashboard may represent a multi-tenant application. In examples, the web-portal or dashboard can be configurable for specific users or groups of users, for example, with respect to customizing the design and visualization of the user interface to output health status information in a specific way, or to restrict access to certain information based on permissions or based on user account, user group, user role, site, applications etc.

In addition to generating a health status 630, the machine health module 104 can also be configured to generate other outputs. For example, the machine health module 104 can be configured to generate an alert 660 in relation to the generated health status 630, at step 214. In some examples, the alert 66i0 will be generated automatically when the health status 630 exceeds a predetermined threshold value, when the health status 630 of the machine 106 changes rapidly or unexpectedly, or when the health status 630 indicates a dangerous condition or failure in the machine 106. The alert 660 can be related to present issues with the machine 106 or can be related to predictions for future events, for example, a prediction that a machine 106 will fail within the next week.

In some embodiments, for example, the machine health module 104 can be integrated with a software-based supervisory control and data acquisition (SCADA) system. In examples, the machine health module 104 may be configured to interface with a customer SCADA/HMI over OPC to pass machine health status 630, health status alerts 660 and/or operational instructions 675 to an existing legacy visualization and control system. In some embodiments, for example, the SCADA system can continually monitor the machine health status 630 or implement operational instructions 675 in order to remotely control the machine 106 or other equipment, for example, to initiate a proactive termination of the machine 106 in response to a health status alert 660 or an operational instruction 175, among other control operations.

At step 216, the processor outputs the alert 660 to the electronic device 108. The alert can be sent to the electronic device 108 in a similar manner as the health status 630. In other examples, users can input the conditions that must be met in order for the machine health module 104 to generate the alert 660. For example, some machines require different expertise to be maintained, for example electrical expertise to deal with electrical faults and mechanical expertise to deal with mechanical faults. In this regard, the user with mechanical expertise may not need alert relating to electrical faults and as such could select specific mechanical conditions during which the alert should be generated by the machine health module 104. By selecting particular alerts, users can more effectively be notified when a fault that they are responsible for remedying occurs, without being overwhelmed by alerts that they cannot address. In this regard, the generation and distribution of alerts may be customized based on permissions, or based on user account, user account category, user role, site, application etc.

In some examples, users of the system 100 may not receive notifications when the machine health status 630 is updated. For example, an increase in bearing temperature may be updated in the web-portal or dashboard, but it is not necessary to generate and output an alert until that increase in temperature is sufficiently large or passes a pre-determined threshold. In this regard, the machine health module 104 may update the bearing temperature, but only send the alert if and when the bearing temperature passes the threshold value. In some examples, the alert may be sent via SMS or e-mail to a user in order to more immediately notify the user of a need to rectify machine 106 faults.

At step 218, the machine health module 104 can be configured to generate an operational instruction 675 based on the health status 630. The operational instruction 675 can be any instruction that arises as a result of the health status 630. For example, the operational instruction 675 could include: an instruction to turn off power to the machine 106; an instruction to alter the performance of the machine 106 (e.g., when the machine 106 is a motor, slowing down the motor or reducing the load on the motor); instructions to replace a component of the machine 106; instructions to replace the machine 106; instructions to reduce ambient temperature or humidity; or any other instruction that can be identified based on the health status 630.

In some systems 100, the server 102 is connected to a controller in the industrial facility. Such controllers allow operators to remotely control machines 106. In this regard, the machine health module 104 can determine, for example, that a machine 106 is in a dangerous electrical condition and needs to be maintained. In response to this determination, the machine health module 104 can also send an operational instruction 675 to the controller to shut off power to the machine 106. By automatically generating and sending the operational instruction 675 to the controller in response to the health status 630 of the machine 106, machines 106 that create dangerous conditions can be remotely shut off in order to mitigate dangerous conditions in the industrial setting and to allow operators to fix or replace the machine 106. In some examples, the operational instruction can relate to a test for the machine 106. For example, when the machine 106 is a motor, the system 100 may require additional information in order to confirm the health status 630 of the machine 106. In such an example, the machine health module 104 may instruct the controller to test the machine 106 by increasing or decreasing the load on the machine 106 for a period of time in order to observe the resulting machine health data and confirm or update the health status 630.

Having generated the operational instruction 675, the processor can also output the operational instruction 675 to the electronic device 108. For example, some industrial settings do not have a controller that remotely controls the machine 106 operation. In such settings, the operational instruction can be sent directly to the user, through their electronic device 108, so they can take the necessary actions. Moreover, some instructions, such as an instruction to replace a component in the machine, can only be completed by a person, and as such, it is necessary to output the operational instruction 675 to the user, rather than sending it to the controller.

FIG. 3 illustrates a schematic diagram of the sensor device 300. In examples, the sensor device 300 can be mounted on an exterior surface of the machine 106, or the sensor device 300 can be connected to the machine 106 in other ways. For example, if the machine 106 is a motor, the sensor device 30) can be aligned perpendicular to the motor shaft axis. The sensor device 300 can have a wireless module 302, and at least one sensor 304. In the example illustrated in FIG. 3, the sensor device 300 has a temperature sensor 304a (e.g., bearing thermocouple, winding RTD, etc.), a vibration sensor 304b (e.g., accelerometer, gyroscope, etc.), a current sensor 304c, an orientation sensor 304d, an optional acoustic sensor 304e and an optional magnetic sensor 304f. In some embodiments, the sensor device 300 includes other sensors, or includes more than one temperature, vibration, current or orientation sensors.

In some examples, the sensors 304 are each integrated into the sensor device 300. In other examples, the machine 106 may have embedded sensors that can be connected to the sensor device 300, such that the sensor device 300 can obtain the sensed data from the embedded sensors and send that sensed data to the processor, via the wireless module. For example, some motors include embedded temperatures sensors, for example, to detect the temperature of the motor winding.

The temperature sensor 304a can be used to detect the temperature of particular components of the machine 106, for example, the bearings. The temperature sensor 304a can also be used to detect an ambient temperature. In some embodiments, the temperature sensor 304a is an infrared temperature sensor. In an embodiment, the sensor device 300 has multiple temperature sensors 304a, for example, when the machine 106 is a motor, multiple temperature sensors 304a may be used for sensing the temperature of the drive-end bearings, the other end bearings, and the stator winding. In some examples, the machine 106 may have integrated temperature sensors. For example, when the machine 106 is a motor, the motor has temperature sensors 304a integrated into the motor, for example, for sensing the motor winding temperatures. In such an example, the sensors 304 include the integrated temperature sensor 304a and the sensor device 300 can send the sensed motor winding temperatures as machine health data to the server 102.

The vibration sensor 304b can be used to sense the vibration of the machine 106. In some embodiments, the vibration sensor 304b is an inertial measurement unit. In other embodiments, the vibration sensor 304b can include an accelerometer and/or a gyroscope. In some embodiments, the vibration sensor 304b is configured to sense vibrations in three axes: radial, axial and tangential.

The current sensor 304c can be used to sense the three phase currents of the machine 106. In some examples, the current sensor 304c can be used to detect certain operational parameters of the machine 106. For example, in a motor, the current can be directly correlated to the speed of the motor. As such, when the machine 106 is a motor, the data sensed from the current sensor 304c can be used to determine the operational speed of the machine 106.

The orientation sensor 304d can be used to sense changes in the orientation of the machine 106. In some embodiments, the orientation sensor 304d can detect the orientation of the machine 106 relative to three axes (e.g. X, Y. and Z axes).

The optional acoustic sensor 304e can be used to sense acoustic signals, for example, sound waves that are inaudible to a human operator. In some embodiments, for example, the acoustic sensor 304e can be an ultrasound sensor.

The optional magnetic sensor 304f can be used to sense changes in the magnetic field of the machine 106. In some embodiments, for example, the magnetic sensor 304f can be a magnetometer. In examples, a magnetometer can generate a magnetometer frequency spectrum corresponding to a magnetic field of the machine 106, for providing to the machine health module 104, for example, for determining a speed of the machine 106. In examples, a peak frequency in the magnetometer spectrum can be identified as corresponding to a supply frequency, which can be used to determine the synchronous speed of the machine 106.

It will be understood that the sensors 304 can include any number and a variety of sensors that are capable of detecting conditions or operating parameters of the machine 106. For example, although not depicted in FIG. 3, the sensors 304 may also include a humidity sensor. Moisture can cause a lot of problems to the machine 106 by causing corrosion of various parts of the machine 106. For example, when the machine 106 is a motor, moisture can corrode the motor insulation, and lead short circuit between the windings, corrode the bearings, motor shaft and rotors. This will prevent the smooth rotation, decrease efficiency and lead to complete failure of the motor. By including a humidity sensor, the machine health module 104 is able to consider moisture content levels in the machine 106, along with other sensed information to determine the health status of the machine 106.

In an example embodiment, the wireless module 302 and the sensors 304 are integrated together into a single component. In another example, the wireless module 302 is a stand-alone component, which is connected to the sensors 304 in order to transmit the data sensed by the sensors 304.

The wireless module 302 can be used to communicate with the server 102, the base unit 500 or the electronic device 108. In some examples, the wireless module 302 includes a communications module, a power module and a microprocessor for packaging the sensed machine health data prior to sending the machine health data to the server 102, the base unit 500 or the electronic device 108. In examples, the wireless module 302 may include a built-in RS-485 interface for communicating with the server 102, the base unit 500 or the electronic device 108. The microprocessor may include an edge logic engine that can use edge computing to process the machine health data into data that is easier for the machine health module 104 to process, for example, by preprocessing the machine health data or extracting features or parameters, for example, based on pre-defined relationships in the data or based on patterns in historical machine health data 625, or based on other information or insights provided to the sensor device 300 by the machine health module 104. By using edge computing, the wireless module 302 can reduce the machine health data being sent to the server 102 into the most critical data points in order to streamline resources and reduce computing time and energy at the server 102. In this regard, the sensor device 300 may be considered as an IOT gateway.

In some examples, the wireless module 302 is configured to detect a status of the sensor device 300. The status of the sensor device 300 may be related to a power status (e.g. low battery), a communications status (e.g. low signal) or a status of the sensor device 300 itself (e.g. a broken sensor). The wireless module 302 can detect this sensor device 300 status and send it to the server 102, the base unit 500, or the electronic device 108.

The sensor device 300 can be installed on the machine 106 in a manner that allows each of the sensors 304 to sense the relevant machine health data. The sensor device 300 can be made of rugged material that allows the sensor device 300 to be installed in harsh industrial environments. In an example embodiment, the sensor device 300 can be installed on the machine 106 using an epoxy putty.

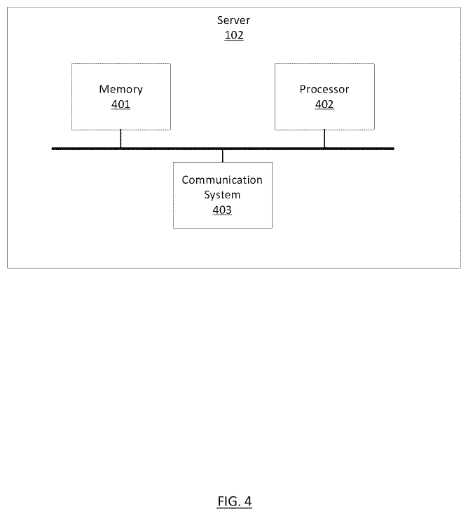

FIG. 4 is a schematic diagram of a hardware structure of the server 102 according to an example embodiment. The server 102 includes a memory 401, a processor 402, and a communications system 403 A communication connection is implemented between the memory 401, the processor 402, and the communications system 403. In some examples, the server 102 is the electronic device 108 or the server may be a cloud-based server.

The processor 402 is configured to perform, when the program stored in the memory 401 is executed by the processor 402, steps of the method 200 of monitoring an industrial machine as described herein.

The memory 401 can be a read-only memory (Read Only Memory, ROM), a static storage device, a dynamic storage device, or a random access memory (Random Access Memory, RAM). The memory 401 may store a program. The memory 401 can be a non-transitory memory. The memory 401 can be external or removable in some examples.

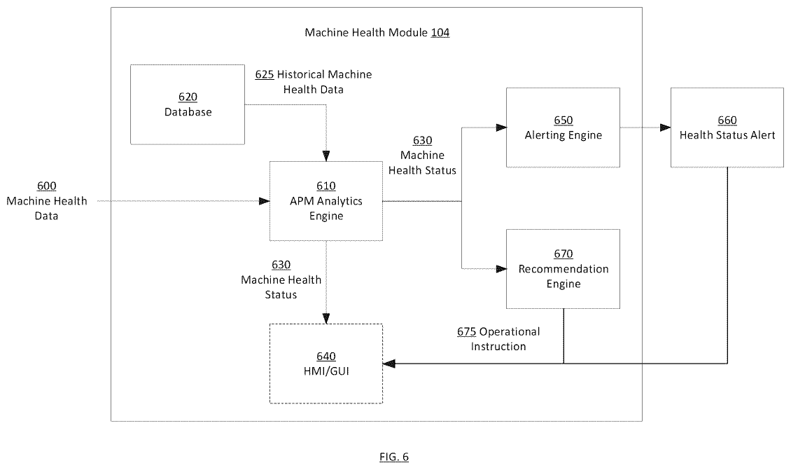

The memory 401 can store data used by the machine health module 104. In examples, machine health data 600, as described below with reference to FIG. 6, can be stored in the memory 401. Models used by the machine health module 104, such as models trained using machine learning (ML) algorithms (as described below with reference to FIG. 6), can be considered to be stored in the memory 401 as part of the machine health module 104. The memory 401 can also store other information or data used in training the models of the machine health module 104, such as training data, and/or other information or data used in executing the machine health module 104.

The processor 402 can be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits.

In addition, the processor 402 may be an integrated circuit chip with a signal processing capability. In addition, the processor 402 can be a general purpose processor, a digital signal processor (Digital Signal Processor, DSP), an application-specific integrated circuit (ASIC), a field programmable gate array (Field Programmable Gate Array, FPGA) or another programmable logic device, a discrete gate or a transistor logic device, or a discrete hardware assembly. The processor 402 can implement or execute the methods, steps, and logical block diagrams that are described in example embodiments. The general purpose processor can be a microprocessor, or the processor may be any conventional processor or the like. The steps of the method disclosed with reference to the example embodiments may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 401. The processor 402 reads information from the memory 401, and completes, by using hardware in the processor 402, the steps of method 200.

The communications system 403 implements communication between server 102, base unit 500 (if necessary), the electronic device 108 and the sensor device 300 by using a transceiver apparatus, for example, including but not limited to a transceiver. The server 102 may include a bus to be used as a path that transfers information between all the components of the server 102.

It should be noted that, although only the memory 401, the processor 402, and the communications system 403 are shown in the server 102 in FIG. 4, in a specific implementation process, a person skilled in the art should understand that the server 102 may further include other components that are necessary for implementing normal running. In addition, based on specific needs, a person skilled in the art should understand that the server 102 may further include hardware components that implement other additional functions. In addition, a person skilled in the art should understand that the server 102 may include only a component required for implementing the embodiments, without a need to include all the components shown in FIG. 4.

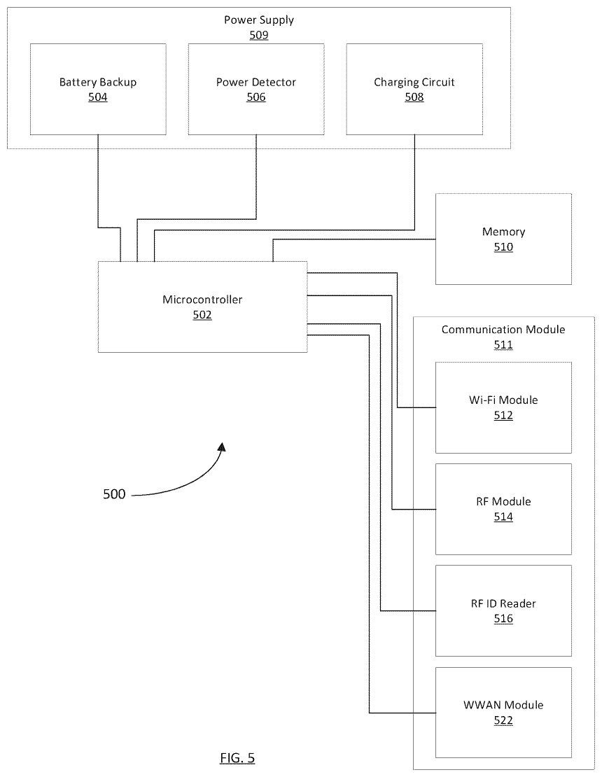

FIG. 5 illustrates an exemplary configuration of the base unit 500. In FIG. 5, the base unit 500 may include a microcontroller 502, a communication module 511, and a power supply module 509.

The microcontroller 502 may include a processor or a central processing unit (CPU), a memory 510 such as a ROM and RAM for storing data, and input or output peripherals. The microcontroller 502 may act as a central controller for controlling all of the communications of the base unit 500 with the sensor devices 300, the server 102, and the electronic device 108. The microcontroller 502 communicates with the sensor devices 300, the server 102, and/or the electronic device 108 via the communications module 511. In some examples, the microcontroller 502 receives data from the sensor devices 300, saves the data to a memory 510, and processes the received data. The data may be real-time data or historical data. The microcontroller 502 may process the data by, for example, comparing data with the preset thresholds, among others. The microcontroller 502 may transmit the results of the processed data to the server 102 or the electronic device 108 via the communication module 511, for example, a Wireless Wide Area Network (WWAN) module 522 or a Wi-Fi module 512. In examples, the microcontroller 502 may direct the transmission of data packets to the server 102 for optimal system performance, for example, the microcontroller 502 and/or the communication module 511 may monitor for packet drops or otherwise monitor network traffic and reroute flows as needed to avoid congestion and ensure optimal performance.

In an example embodiment, the microcontroller 502 may be configured to upload the data received from the sensor devices 300, or the processed results of the sensed data to the server 102 through the communication module 511. The microcontroller 502 may send data, including the sensed data from the sensor devices 300, to the server 102 periodically, such as once every hour, to update the server 102 with, for example, the latest temperature of vibration data for one or more machines 106, among other information. Further, such sensed data, detected by the sensor devices 300 can then be transmitted from the server 102 to the electronic device 108 (e.g. push or pull). In an example, as a default, wireless communications between the base unit 500 and the server 102 use the WWAN, and bypass (do not use or require) any Wi-Fi Network. For example, Wi-Fi networks may be prone to power outages.

The communication module 511 can include a short range communication that is used to determine that a sensor de % ice 300 is placed in proximity to the base unit 500. The communication module 511 may include a radiofrequency identification (RF ID) reader 516, a WWAN module 522, an RF module 514, and/or a Wi-Fi module 512. The microcontroller 502 controls the communication module 511.

The WWAN module 522 functions as a wireless communication module for the base unit 500 to access standard wireless communications services, such as communications services provided by GSM, GPRS, 3G, LTE, and 5G wireless networks. In some examples, the WWAN module 522 also includes a subscriber identity module or subscriber identification module (SIM) card, which allows the base unit 500 to use commercially available wireless communications services. In some examples, a PIN code may be used to protect the SIM card. The pin code may be programmed to prevent the SIM card from being removed from the base unit 500 and used in another compatible device. The WWAN module 522 may make HTTP request over Secure Sockets Layer (SSL) and open a TCP socket over SSL so that the WWAN module may access a RESTful API using TCP/IP protocol.

RF module 514 allows the base unit 500 to transmit and/or receive data in the form of wireless signals with the corresponding RF module of the sensor devices 300, using for example unlicensed frequency spectrum, for example on 900 MHz band. Example embodiments that refer to the unlicensed frequency spectrum can also be applied to one unlicensed frequency channel. The RF module 514 may include power amplifying circuits for amplifying the RF signals, and frequency modulation circuits for modulating the signals to the selected radio frequency, and antennas for the RF signals to be radiated to or from the sensor devices 300.

The Wi-Fi module 512 provides circuits that enable the base unit 500 to use Wi-Fi networks and to transmit data to or from the server 102 or sensor devices 300. For example, the Wi-Fi module 512 may include a Wi-Fi transceiver. A user may use the electronic de % ice 108 to configure the Wi-Fi module 512 via the server 102, for example, via a cloud based web-portal. The Wi-Fi configuration process will be described in great detail below.

The Wi-Fi module 512 may scan available Wi-Fi networks, and connect the base unit 500 to a selected Wi-Fi network. The Wi-Fi module 512 may detect loss of the Wi-Fi networks and loss of the Internet connection. As well, the Wi-Fi module 512 may make HTTP request over SSL and open a TCP socket over SSL so that the Wi-Fi module 512 may access a webpage using TCP/IP protocol. In some examples, all of the communications between the base unit 500 and the server 102 is encrypted.

In some examples, the base unit 500 may first activate the WWAN module 522 as the primary communication module when the base unit 500 is started, for example, powered on. The base unit 500 may then set up the Wi-Fi module 512. The base unit 500 may use the Wi-Fi module 512 if the signal strength or traffic rate of the Wi-Fi is better than that of the WWAN, or if the WWAN is not available, or if Wi-Fi is a desired lower cost modality as set by a user through the electronic device 108.

In the example of FIG. 5, the power supply module 509 includes a charging circuit 508, a power detector 506 and a battery backup 504. The charging circuit 508 receives the power from an electrical outlet of a premises, converts the received power to appropriate voltage and current, and supplies the converted power to various elements of the base unit 500. The battery backup 504 may include rechargeable battery, such as rechargeable Lithium ion battery. The charging circuit 508 may directly supply the converted power to the battery backup 504 for charging the rechargeable battery, the microcontroller 502, and communication module 511. In another example, the charging circuit 508 supplies the converted voltage and current to the battery backup 504 for charging the rechargeable battery, and the rechargeable battery of the battery backup 504 supplies power to the base unit 500, such as the microcontroller 502, and communication module 511. The power supply module 509 may also include a switch to turn on or off of the base unit 500.

The power supply module 509 may include a power detection circuit, such as a power detector 506, to determine when outlet power is lost. The power detector 506 can be a presence/absence power detector 506 in an example embodiment. In another example embodiment, the power detector 506 measures the specific signal from the outlet (e.g., power, voltage, or current). When the input power from the outlet of the premises is lost, drops below a threshold, or is fluctuating, the battery backup 504 is configured to seamlessly supply power to the base unit 500, for example, by the rechargeable battery. Typically, the rechargeable battery is capable of supplying power the base unit for at least 24 hours. In some examples, the microcontroller 502 may report the remaining power of the battery to the server 102 and the electronic device 108. When the power is lost, the microcontroller 502 reports the power loss to the server 102 as an alert event, for example via HTTP request and/or to the electronic device 108 via emails, text messages, or push notification. As well, the base unit 500 may use only the W WAN module 522 to transmit the data received from the sensor devices 300 to the server 102 in an example embodiment, the RF module 514 remains active for receiving messages, such as anomalies, from the sensor devices 300, and the Wi-Fi module 512 may be temporarily disabled to save the battery pow er.

FIG. 6 is a block diagram of a machine health module 104, according to an example embodiment. The machine health module 104 may be a software that is implemented in the server 102 of FIG. 4, in which the processor 402 is configured to execute instructions stored in the memory 401 to cause the server 102 to implement the machine health module 104. The machine health module 104 includes an Asset Performance Management (APM) analytics engine 610, an alerting engine 650 and a recommendation engine 670. In examples, the APM analytics engine 610 may be configured to interface with an optional human machine interface (HMI) or graphical user interface (GUI) 640, such as a web-portal or dashboard, for displaying indications of machine health status 630, among other information.

In examples, the machine health module 104 can receive machine health data 600 from the sensor device 300 or the base unit 500. In examples, the machine health data 600 can include time-series data representative of a current state of the machine 106, including temperature(s) of the machine 106, machine vibrational information, machine acoustic information, machine orientation information, machine ultrasonic information, machine magnetic information, machine humidity information or machine electrical information, among others. In examples, time-series data represents a sequence of data points indexed in time order, for example, including successive data samples corresponding to a data source sampled at fixed time intervals. In examples, the APM analytics engine 610 can also retrieve historical machine data 625 for the machine 106 or for other machines from a database 620, for example, stored as time-series data samples or other forms of data samples, in the memory 401 of server 102, or stored on another server. In examples, the APM analytics engine 610 can analyze the historical machine health data 625 to identify patterns or other useful features in the machine health data 625 to assist in monitoring, diagnosing and predicting the health state 630 of the machine 106.

In some embodiments, for example, the machine health data 600 can be preprocessed by the sensor device 300, the base unit 500 or the APM analytics engine 610. For example, a fast Fourier transform (FFT) analysis may be performed on the machine health data 600 for calculating various frequency components and for obtaining an overall RMS value for each time-series sequence (e.g., acceleration, velocity, temperature, magnetic etc.) in the machine health data 600, among others.

In examples, the APM analytics engine 610 can include a time-series prediction algorithm for monitoring and forecasting machine health, for example, including sensor health and performance (e.g., having regard to the operational thresholds indicated by the ISO 10816-3 standard), machine health status 630 over various forecast periods, or for forecasting individual fault conditions associated with the machine 106 or a machine being driven by the machine 106, among others. In some embodiments, the time-series prediction algorithm may be a modified Holt exponential smoothing algorithm, for forecasting a value of a time-series data sequence at a future time t+1, based on a historical trend in the data. An example of the Holt exponential smoothing algorithm is described in: Holt. Charles C. “Forecasting seasonals and trends by exponentially weighted moving averages.” International journal of forecasting 20.1 (2004): 5-10, the entirety of which is hereby incorporated herein by reference. In examples, the time-series prediction algorithm may output a predicted value ŷₜ₊₁ of time-series data sequence y at time t+1, using equation 1 below:

$${\hat{y}}_{t + 1} = {L}_{t} + {T}_{t} \qquad ( 1 )$$

where Lₜ is the expected base level for the time-series data sequence at time t and Tₜ is the expected trend in the time-series data at time t. In examples, Lₜ and Tₜ can be calculated using equations 2 and 3, respectively.

$${L}_{t} = α {y}_{t} + ( 1 - α ) ( {L}_{t - 1} + {T}_{t - 1} ) \qquad ( 2 )$$

$${T}_{t} = β ( {L}_{t} - {L}_{t - 1} ) + ( 1 - β ) {T}_{t - 1} \qquad ( 3 )$$

where α and β are smoothing parameters, yₜ is a time-series data sequence, Lₜ₋₁ is the expected base level for the time-series data sequence at time t−1 and Tₜ₋₁ is the expected trend in the time-series data at time t−1 and where 0≤α≤1 and 0≤β≤1. In examples, in a traditional Holt exponential smoothing algorithm, the values of α and β are fixed.

In examples, values of α and β can be updated in an adaptive manner based on the most recent data samples corresponding to a time-series data sequence in the machine health data 600. In this regard, the time-series prediction algorithm represents a modified Holt method for predicting machine health status that better reflects of the current state of the machine 106. In some embodiments, for example, as new machine health data 600 is received by the APM analytics engine 610, values for α and β can be optimized in real-time using a regression model, for example, using a least squares estimator (LSE) to determine the values of α and β that minimize an error term. In examples, the regression analysis can be performed using a pre-determined number of recent data points. In some embodiments, for example, the pre-determined number of recent data points used in the regression analysis can be 12, or another number can be used. In examples, each of the pre-determined number of data points used in the regression analysis can represent an average value of a set of data sample values in the time-series. In examples, the number of data sample values used in calculating the average value may depend on the sampling frequency and the forecast period (e.g., hourly, weekly, monthly, yearly etc.). To demonstrate how sampling frequency and forecast period can inform the calculation of data points for the regression analysis, an example will now be described. For example, for a sampling frequency of 15 minutes and an hourly forecast period, each data point used in the regression analysis can represent an average of four data samples obtained over a period of one hour. In examples, the 12 data points used in the regression analysis therefore can represent a respective average of four data samples obtained over a respective one hour of a recent 12 hour period. In examples, with each new data sample of the machine health data 610 that is received by the APM analytics engine 610, the values of α and β can be updated as described above, to reflect the new data. In another example, for a sampling frequency of 15 minutes and a weekly forecast period, each data point used in the regression analysis can represent a respective average of 672 data samples (e.g., 4 data samples per hour over 7 days) obtained over a respective one week of a recent 12 week period. In examples, similar logic may be extended to monthly or yearly forecast periods, among others.

In examples, the APM analytics engine 610 can be configured to generate a machine health status 630 including an assessment or diagnosis of the current state of the machine 106 and/or a prediction of a future state of the machine 106, for example, based on an integrated analysis of the machine health data 600 and/or the historical machine health data 625. In some embodiments, for example, the APM analytics engine 610 can be a trained prediction machine learning (ML) model that processes a plurality of machine health parameters to predict a machine health status 630 corresponding to a current operating state of the machine 106 or a future operating state of the machine 106, for example, based on hourly, daily, weekly, and/or monthly forecast timelines. In examples, a HMI/GUI 640 of the machine health module 104 may be configured to receive the machine health status 630 for displaying to a user, for example, in a web-portal or dashboard.

In some embodiments, for example, the machine health status 630 may be generated based on one or more machine health indices, for example, based on a mechanical health index, an electrical health index, a thermal health index and/or a ball bearings index. In examples, a machine health index can include an index value between 0 and 100. In examples, the machine health index can describe a machine health status as “healthy” or “green” when the index value is between 85 and 100, as “unsatisfactory” or “yellow” when the index value is between 60 and 84.9 and as “unacceptable” or “red” when the index value is less than 59.9.

In examples, the mechanical health index (MHI) can be calculated based on vibration information for the machine 106, for example, RMS values of velocity and acceleration in all three axes (e.g., radial, axial and tangential velocity and acceleration) as measured for the machine 106 and received by the APM analytics engine 610. In examples, the MHI can be calculated using equation 4 below

$$MHI = \frac{( {V}_{score} \times 20 ) + ( {C}_{score} \times 10 )}{3000} \times 100 \qquad ( 4 )$$

where V_{score} is a velocity score for the machine 106 and C_{score} is a condition score for the machine 106, and where the denominator is chosen to normalize the index to 100. In examples, the condition score can be representative of an individual fault condition for the machine 106, for example, mechanical unbalance, misalignment, looseness, soft foot, bearing faults, electrical unbalance and/or a transverse mounting issue, among others.

In examples, to obtain the velocity score for the machine 106, the radial, axial and tangential velocity can be obtained from the vibration information for the machine 106 and the axis with the highest magnitude velocity measurement can be selected for inclusion in the calculation. In examples, the velocity measurement associated with the selected axis can be compared to threshold limits with reference to the ISO 10816-3 standard, where a velocity measurement falling within the limits of “good health” or “green” can be assigned a velocity score of 10, a velocity measurement falling within the limits of “unsatisfactory” or “yellow” can be assigned a velocity score of 8 and velocity measurement falling within the limits of “unacceptable” or “red” can be assigned a velocity score of 4. In examples, the velocity score can be multiplied by a factor of 20. In examples, to obtain the condition score C_{score} for the machine 106, the vibration information for the machine 106 is compared to threshold limits for each of the one or more individual fault conditions with reference to the ISO 10816-3 standard. In examples, a condition score of 10, 8 or 4 can be assigned based on the “good health”, “unsatisfactory” and “unacceptable” threshold limits, respectively, for each of the individual fault conditions, and a minimum condition score can be selected for inclusion in the mechanical health index calculation.

To demonstrate how a machine health index value can be calculated, an example will now be described. For example, a machine 106 indicates a V_{score} of 8, and potential C_{score} of 4 for mechanical unbalance, 10 for angular misalignment or bent shaft, 10 for looseness, 10 for parallel misalignment, 10 for soft foot or 10 for mounting structure. In examples, the C_{score} is therefore set at 4 based on the requirement to select the minimum index score for individual fault conditions. In examples, the MHI is calculated to be 67 as shown in equation 5 below. In examples, a MHI of 67 corresponds to an “unsatisfactory” status.

$${MHI}_{Example} = \frac{( 8 \times 20 ) + ( 4 \times 10 )}{3000} \times 100 = 67 \qquad ( 5 )$$

In examples, the electrical health index (EHI) can also be calculated based on vibration information for the machine 106, for example, RMS values of velocity and acceleration in all three axes (e.g., radial, axial and tangential velocity and acceleration) as measured for the machine 106 and received by the APM analytics engine 610, or based on motor current signature analysis (MCSA). In examples, the EHI can be calculated in a similar manner to that used for calculating the mechanical health index, for example, using equation 6 below.

$$EHI = \frac{( {V}_{score} \times 20 ) + ( {C}_{score} \times 4 )}{2400} \times 100 \qquad ( 6 )$$

where V_{score} is a velocity score for the machine 106 and C_{score} is a condition score for the machine 106, and where the denominator is chosen to normalize the index to 100.

In examples, a thermal health index (THI) can be calculated by taking the largest of the stator winding temperature and by computing the remaining lifetime of the machine 106, for example, a running average of the remaining lifetime of the machine 106 over a period of the previous seven days. In examples, remaining lifetime above 200,000 hours can be assigned a thermal score of 10, a remaining lifetime between 50,000 and 200,000 hours can be assigned a thermal score of 8, and a remaining lifetime below 50,000 hours can be assigned a thermal score of 4. In examples, the THI can be obtained by normalizing the thermal score to 100.

In examples, a ball bearing health index (BBHI) can be calculated based on temperature information, vibration information and optionally, ultrasound information as measured for the machine 106 and received by the APM analytics engine 610. In examples, the BBHI can be calculated in a similar manner to that used for calculating the MHI, for example, using equation 7 below.

$$BBHI = \frac{( {T}_{score} \times 20 ) + ( {C}_{score} \times 40 ) + ( {U}_{score} \times 20 )}{8000} \times 100 \qquad ( 7 )$$

where T_{score} is a temperature score for the machine 106, C_{score} is a condition score for the machine 106, for example, related to a bearing fault condition, and U_{score} is an optional ultrasound score related to an early stage bearing fault condition, and where the denominator is chosen to normalize the index to 100. In examples, to obtain the temperature score T_{score} for the machine 106, the bearing temperature on the drive end side and the non-drive end side can be obtained from the temperature information for the machine 106 and the bearing position with the highest magnitude temperature measurement can be selected for inclusion in the calculation. Similarly, to obtain the condition score C_{score} for the machine 106, the vibration information for the machine 106 is compared to threshold limits for a bearing fault condition at the drive-end side or a bearing fault condition at the non-drive-end side with reference to the ISO 10816-3 standard, and a minimum condition score can be selected for inclusion in the mechanical health index calculation.

In examples, an overall machine health index can be calculated for the machine 106, for example, where the machine 106 is a motor as the sum of the MHI, EHI, THI and BBHI normalized to 100. In examples, for other machines, the overall machine health index can be calculated as the sum of the MHI and BBHI normalized to 100.

In some embodiments, for example, the APM analytics engine can also include a resolution compensation algorithm, for example, for determining an operating speed of a machine 106 based on a magnetometer spectrum. In examples, the resolution compensation algorithm can be used to fine tune an estimated supply frequency, for example, using equation 8.

$$Peak = F - \frac{Z - X}{2 ( Z - 2 Y + X )} f \qquad ( 8 )$$

where F is a peak frequency (Hz) obtained from a FFT spectrum, having a value of Y, X is a value on the immediate left of F in the FFT spectrum. Z is the value on the immediate right of F in the FFT spectrum, and f is the frequency resolution.

In some embodiments, for example, when the machine 106 is an induction motor, a true peak supply frequency can be determined using the resolution compensation algorithm, and a synchronous speed can be determined based on the true peak supply frequency. In examples, a peak vibration frequency can be determined from the vibration spectrum (e.g., where the peak vibration frequency can be below the true peak supply frequency), and can be similarly tuned using the resolution compensation algorithm to obtain a true vibration frequency value. In examples, there may exist multiple peaks in the vibration spectrum, therefore the peak vibration frequency of interest can be the peak immediately below the determined true peak supply frequency. In examples, a machine operating speed can be determined based on the true vibration frequency. In some embodiments, for example, when the machine 106 is a synchronous motor, the synchronous speed and the machine operating speed can be determined based on the true peak supply frequency obtained from the magnetometer spectrum (e.g., without requiring the vibration spectrum).

In examples, the speed of the non-electrical driven machine cannot be estimated using the above method, since it doesn't generate an electrical signature for the magnetometer. Therefore, once the operating speed of the Driver (e.g., an induction motor that is driving the driven equipment) is determined as per the above described example with respect to equation 8, the operating speed of the driver can be applied as the operating speed of the driven machine for diagnostics and predictions purposes.

In examples, the alerting engine 650 can receive information from the APM analytics engine 610 about the machine health status 630, including, for example, machine health indices, or prediction information, among other machine health status information. In some examples, the alerting engine 650 may generate a health status alert 660 when the machine health status 630 exceeds a predetermined threshold value, when the health status of the machine 106 changes rapidly or unexpectedly, or when the health status indicates a dangerous condition or failure state in the machine 106, among others. The health status alert 660 can be related to present conditions or other current issues with the machine 106 or can be related to predictions for future events, for example, a prediction that a machine 106 will fail within the next week. In some examples, the health status alert 660 may be sent to the electronic device 108 via short messaging service (SMS) or via e-mail. In other examples, the machine health module 104 may be integrated with a customer SCADA/HMI over OPC to pass the health status alert 660 to an existing legacy visualization system.

In some embodiments, for example, the alerting engine 650 can be a machine learning model or in other embodiments the alerting engine 650 can be a rules based model, or another type of model may be used. An example of the rules based model for the alerting engine 650 is a rules-based classifier or another rules-based method that relies on a set of predetermined rules that can be applied to the machine health status 630 (e.g., applied to machine health indices) in order to trigger the sending of a health status alert 660. In an example, a set of predetermined rules may include: 1. If a temperature value of the NDE bearing, the stator winding or the DE bearing exceeds a temperature of 85° C. (185° F.) or is below a temperature of 0° C. (32° F.), trigger a temperature alert. 2. If a vibration value of the tangential acceleration, axial acceleration or radial acceleration exceeds 7.0 m/sec², trigger a mechanical unbalance alert.

In examples, the recommendation engine 670 can also receive information from the APM analytics engine 610 about the machine health status 630, including, for example, machine health indices or prediction information, among other machine health status information, in order to generate an operational instruction 675. In examples, the operational instruction 675 can effective for mitigating risks associated with current or predicted performance of the machine 106 and for establishing an operating state of the machine 106 that is optimized. For example, the operational instruction 675 could include: an instruction to turn off power to the machine 106; an instruction to alter the performance of the machine 106 (e.g. when the machine 106 is a motor, slowing down the motor or reducing the load on the motor); instructions to replace a component of the machine 106; instructions to replace the machine 106; instructions to reduce ambient temperature or humidity; or any other instruction or recommendation that can be identified based on the machine health status 630. In some embodiments, for example, the recommendation engine 670 can be a machine learning model or in other embodiments the recommendation engine 670 can be a rules based model, or another type of model may be used. An example of the rules based model for the recommendation engine 670 is a rules-based classifier or another rules-based method that relies on a set of predetermined rules that may be applied to the machine health status 630 in order to trigger the generation of an operational instruction 675. In an example, a set of predetermined rules may include: 1. If a temperature value of the NDE bearing, the stator winding or the DE bearing exceeds a temperature of 85° C. (185° F.) or is below a temperature of 0° C. (32° F.), trigger a recommendation to, 2. If a vibration value of the tangential acceleration, axial acceleration or radial acceleration exceeds 7.0 m/sec², trigger a mechanical unbalance alert.

In examples, a HMI/GUI 64(of the machine health module 104 may be configured to receive the health status alert 660 and any operational instructions 675 for displaying to a user, for example, in a web-portal or dashboard.

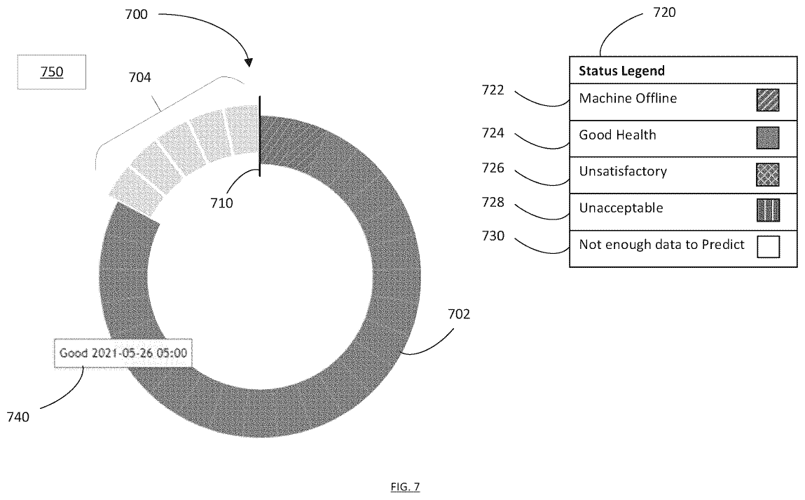

In some embodiments, for example, the machine health status 630 can include a machine health condition assessment (e.g., described with respect to FIG. 7), for example, for predicting a future machine health condition for the one or more individual fault conditions of the machine 106. In examples, individual fault conditions for the machine 106 can be determined by the time-series prediction algorithm based on triaxial vibration harmonics exceeding certain threshold values, for example, with reference to the ISO 10816-3 standard.

FIG. 7 is a schematic diagram of a visual representation of a machine health condition assessment 700, according to an example embodiment. In examples, the visual representation includes actual performance 702 and predicted performance 704 of a mechanical unbalance condition on an hourly timescale. In examples, a measure of the absolute percentage error 750 as determined between the actual performance 702 and the predicted performance 704 may be displayed in the visual representation. In examples, a starting point 710 for the visual representation can indicate a time (e.g., 12 AM) at which the monitoring of actual performance 702 began, and which may be adjusted depending on whether the monitoring and forecasting period is hourly, daily, weekly or monthly.

In examples, a legend 720 may be provided to indicate the health status during each time frame in the visual representation, for example, for indication periods where the machine 106 is offline 722, in good health 724, in unsatisfactory health 726, in unacceptable health 728 or when there may not be enough data to generate a prediction 730. In examples, a condition status indicator 740 may be provided in the visual representation to indicate a time-stamped condition status with respect to the particular fault condition (e.g., mechanical unbalance is good as of 2021-05-25 5:00).

In examples, machine health condition assessment can determine a good health 724, unsatisfactory 726 and unacceptable 728 condition based on time-series data or frequency domain data, among others data formats received by the APM analytics engine 610, and with respect to machine performance thresholds indicated in the ISO 10816-3 standard.

It should be understood that the examples provided above are exemplary only, and that in various embodiments, the alerting engine 650 and recommendation engine 670 may include various rules to be applied to various aspects of machine health status 630, including machine health indices, clusters of machine health indices, etc.

The various embodiments presented above are merely examples and are in no way meant to limit the scope of this disclosure. Variations of the innovations described herein will be apparent to persons of ordinary skill in the art, such variations being within the intended scope of the example embodiments. In particular, features from one or more of the above-described embodiments may be selected to create alternative embodiments comprises of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the example embodiments as a whole. The subject matter described herein intends to cover all suitable changes in technology.

Certain adaptations and modifications of the described embodiments can be made. Therefore, the above discussed embodiments are considered to be illustrative and not restrictive.

Although the example embodiments relate to methods and processes with steps in a certain order, one or more steps of the methods and processes may be omitted or altered as appropriate One or more steps may take place in an order other than that in which they are described, as appropriate.

Although example embodiments are described, at least in part, in terms of methods, a person of ordinary skill in the art will understand that the example embodiments are also directed to the various components for performing at least some of the aspects and features of the described methods, be it by way of hardware components, software or any combination of the two. Accordingly, the technical solution of the example embodiments may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable an electronic device (e.g., a personal computer, a server, or a network device) to execute examples and example embodiments of the methods.

In the described methods, systems, devices, or block diagrams, the boxes may represent events, steps, functions, processes, modules, messages, and/or state-based operations, etc. While some of the example embodiments have been described as occurring in a particular order, some of the steps or processes may be performed in a different order provided that the result of the changed order of any given step will not prevent or impair the occurrence of subsequent steps. Furthermore, some of the messages or steps described may be removed or combined in other embodiments, and some of the messages or steps described herein may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

The example embodiments may be embodied in other specific forms without departing from the subject matter of the example embodiments. The described example embodiments are to be considered in all respects as being only illustrative and not restrictive. Selected features from one or more of the above-described embodiments may be combined to create alternative embodiments not explicitly described, features suitable for such combinations being understood within the scope of the example embodiments.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method for monitoring an industrial machine having a rotating component and at least one sensor coupled to the industrial machine, the at least one sensor for sensing machine health data corresponding to a current operating condition of the industrial machine, the method comprising:
receiving, from the at least one sensor, the machine health data;
generating, using a machine health module, a machine health status corresponding to the current operating condition of the industrial machine based on the machine health data; and
communicating, to an electronic device, a representation of the machine health status, to cause the electronic device to provide an output of the representation of the machine health status.

2. The method of claim 1, further comprising:
determining, by the machine health module, that the current operating condition of the industrial machine corresponds to a non-optimal operating condition, based on the machine health status;
in response to determining that the operating condition of the industrial machine is non-optimal:
generating, by the machine health module, an alert; and
communicating the alert to the electronic device.

3. The method of claim 1, further comprising:
determining, by the machine health module, that the current operating condition of the industrial machine corresponds to a non-optimal operating condition, based on the machine health status;
in response to determining that the operating condition of the industrial machine is non-optimal:
generating, by the machine health module, an operational instruction; and
communicating the operational instruction to the electronic device.

4. The method of claim 1, further comprising:
diagnosing, by the machine health module, a machine health condition of the industrial machine, based on the machine health data.

5. The method of claim 1, wherein generating the machine health status corresponding to the current operating condition of the industrial machine comprises:
computing one or more machine health index values; and
computing the machine health status based on the one or more machine health index values.

6. The method of claim 5, wherein generating the machine health status corresponding to the current operating condition of the industrial machine further comprises:
predicting, by a time-series prediction algorithm, a future state of the industrial machine.

7. The method of claim 6, wherein the time-series prediction algorithm is a modified Holt exponential smoothing algorithm.

8. The method of claim 1, wherein the industrial machine is a first machine, the first machine being coupled to a second machine and configured as a driver for driving the second machine, and wherein generating the machine health status corresponding to the current operating condition of the industrial machine further comprises:
determining, by a resolution compensation algorithm, a true peak supply frequency from a magnetometer spectrum;
determining a synchronous speed of the first machine based on the true peak supply frequency; and
determining a rotating speed of the second machine based on the synchronous speed of the first machine.

9. The method of claim 1, wherein the industrial machine is a first machine, the first machine being coupled to a second machine and configured as a driver for driving the second machine, and wherein generating the machine health status corresponding to the current operating condition of the industrial machine further comprises:
determining, by a resolution compensation algorithm, a true peak supply frequency from a magnetometer spectrum;
determining a synchronous speed of the first machine based on the true peak supply frequency;
determining, by the resolution compensation algorithm, a true vibration frequency from a vibration spectrum;
determining an operating speed of the first machine based on the true vibration frequency; and
determining a rotating speed of the second machine based on the synchronous speed and the operating speed of the first machine.

10. The method of claim 1, wherein the electronic device is caused to display a user interface (UI) enabling output of the representation of the machine health status.

11. The method of claim 10, wherein the representation of the machine health status is configurable based on a multi-tenant application using at least one of: a user account, a user permissions, a user group, a user role, or a site.

12. The method of claim 10, wherein the representation of the machine health status includes a plot of at least a portion of the machine health data over time.

13. The method of claim 1 wherein the at least one sensor includes at least one of: a temperature sensor, a vibration sensor, an acoustic sensor, an ultrasonic sensor, a magnetic sensor, a current sensor, an orientation sensor, or a humidity sensor.

14. The method of claim 1, wherein the machine health data includes at least one of: machine temperature data, machine vibrational data, machine acoustic data, machine ultrasound data, machine magnetic data, machine electrical data, machine operational data, machine orientation data, or machine humidity data.

15. The method of claim 14, wherein the machine health module includes a trained prediction machine learning (ML) model.

16. The method of claim 15, further comprising training a prediction ML model to provide the trained prediction ML model, comprising:
obtaining multiple historical machine health data samples corresponding to a respective historical operating condition of the industrial machine; and
training the prediction ML model based on the historical machine health data samples.

17. The method of claim 2, wherein the machine health module is configured to automatically send the alert to at least one electronic address.

18. The method of claim 2, wherein the machine health module is configured to automatically send the alert to at least one telephone number via short messaging service.

19. The method of claim 3, wherein the machine health module is configured to automatically send the operational instruction to a controller of the industrial machine, wherein the controller is configured to control operation of the industrial machine.

20. The method of claim 3, wherein the machine health module is configured to communicate with a supervisory control and data acquisition (SC AD A) system.

21. The method of claim 1, further comprising:
generating, using the machine health module, a sensor health status corresponding to the current operating condition of the at least one sensor, based on the machine health data; and
communicating, to an electronic device, a representation of the sensor health status, to cause the electronic device to provide an output of the representation of the sensor health status.

22. The method of claim 21, further comprising:
diagnosing, by the machine health module, a sensor operation issue of the at least one sensor, based on the sensor health status.

23. The method of claim 21, wherein the sensor health status includes at least one of a power status of the sensor device, a communications status of the sensor device or a machine trouble status of the sensor device.

24. The method of claim 1, wherein the machine health data is received continuously.

25. The method of claim 1, wherein the machine health data is received at pre-determined intervals.

26. The method of claim 1, wherein the machine health data is received over an equipment operational period.

27. A computer implemented method for monitoring a plurality industrial machines having a rotating component, and a respective sensor device for sensing machine health data corresponding to a current operating condition of the respective industrial machine, the method comprising:
receiving, from a base unit, machine health data corresponding to a plurality of sensor devices identified as being in proximity to the base unit;
generating, using a machine health module, a machine health status corresponding to the current operating condition of each of the plurality of industrial machines, based on the machine health data; and
communicating, to an electronic device, a representation of the machine health status of each of the plurality of industrial machines, to cause the electronic device to provide an output of the representation of the machine health status of each of the plurality of industrial machines.

28. A non-transitory memory containing instructions and statements which, when executed by a processor, cause the processor to perform the method of claim 27.

29. A system for monitoring an industrial machine having a rotating component, the system comprising:
a sensor device connected to the industrial machine, the sensor device including at least one sensor and configured for sensing machine health data corresponding to a current operating condition of the industrial machine;
a machine health server;
one or more processor devices; and
one or more memories storing machine-executable instructions, which when executed by the one or more processor devices, cause the system to:
receive, from the at least one sensor, the machine health data;
generate, using a machine health module, a machine health status corresponding to the current operating condition of the industrial machine based on the machine health data; and
communicate, to an electronic device, a representation of the machine health status, to cause the electronic device to provide an output of the representation of the machine health status.

30. The system of claim 29, wherein the machine health server includes a multi-layer data storage architecture including a database for storing historical machine health data, and the historical machine health data may include tags or data reference points for improving data retrieval.

31. The system of claim 29, wherein the machine health server is a cloud-based server.

32. A device for performing the method of claim 27.

33. A sensor device for monitoring an industrial machine having a rotating component, comprising:
at least one sensor for sensing machine health data; and
a wireless module for transmitting machine health data sensed by the at least one sensor.
